(19) United States
(12) Patent Application Publication
(10) Pub. No.: US 2009/0328137 A1
(43) Pub. Date: Dec. 31, 2009

(54) METHOD FOR PROTECTING DATA IN MASHUP WEBSITES

(76) Inventors: Wen-Tien Liang, Pingihen City (TW); Shun-Fa Yang, Taipei (TW)

Correspondence Address: IPSG, P.C., P.O. BOX 700640, SAN JOSE, CA, 95170, US

(21) Appl. No.: 12/164,904

(22) Filed: Jun. 30, 2008

(51) Int. Cl. G06F 21/00

(52) U.S. Cl. 726/1

(57) ABSTRACT

A method for protecting a mashup webpage is disclosed. The mashup webpage includes a plurality of mini-applications. The method includes intercepting a content access event by a first mini-application of the plurality of mini-applications, the content access event requesting access to content of a second mini-application of the plurality of mini-applications. The method also includes ascertaining, using a Document Mini-application Model (DOM) access control policy and a DOM model, whether the content access event is permissible. The method additionally includes denying the access by the first mini-application to the content of the second mini-application if the content access event is deemed impermissible or permissible according to the DOM access control policy.

### BACKGROUND OF THE INVENTION

One service that is quickly gaining popularity on the Internet is mashup websites. Mashup websites are web applications comprising of merged mini applications (referred to herein as “gadgets”) from one or more third-party sources. The gadgets may be combined within a common framework using, for example, a common Application Programming Interfaces (API), in order to create a single integrated mashup website that provides services by the gadgets.

An example of a mashup website is iGoogle™. iGoogle™ is, among other things, a user-customizable homepage in the sense that iGoogle™ allows a user to customize their homepage via gadgets. A user may, upon signing up with the iGoogle™ service, select gadgets available from a variety of sources, including third party sources, in order to customize their own personal iGoogle™ homepage. These gadgets may include applications and/or tools from within the organization or from third-party sources.

For example, a user employing the iGoogle™ framework may desire to customize their homepage to include third-party gadgets that implement stock quotes, games, music, dictionary lookups, current news, weather etc. The user may also have the additional option to create their own gadget(s) to share with other users utilizing the iGoogle™ platform. Further information about iGoogle™ may be obtained from online sources, including http://www.google.com/ig and http://en.wikipedia.org/wiki/IGoogle. Since the resultant homepage is an aggregation of various gadgets and data sources, iGoogle™ may be thought of as an example of a mashup website.

The popularity of mashup websites also make gadgets an avenue through which hackers may steal personal data, for example, credit card numbers, social security numbers, login credentials, addresses, or phone numbers etc., from users that utilize the mashup websites. Once the hacker has successfully stolen the personal data from a user, the hacker can then cause far-reaching damage (e.g., depleting bank accounts, identity theft, making unauthorized charges, harassment, etc.)

A popular method by which hackers may steal this personal data is by providing malicious gadgets for victims to subscribe to. Once the victim has subscribed to a malicious gadget and adds the malicious gadget to their mashup webpage, codes in the malicious gadget may, for example, attempt to steal the victim's personal data. The victim's personal data may then be sent back, for example, to a website designated by the hacker or to the website from which the malicious gadget is obtained.

Consider the situation wherein, for example, victim A subscribes to the xyzwidget gadget that has been set up by a hacker on the website www.xzywidgets.com in order to personalize their iGoogle™ webpage. Once victim A logs on to his iGoogle™ account, iGoogle™ will then connect to the website specified by the codes of the xyzwidget gadget to load xyzwidget's content on to his customized homepage. Now, the xyzwidget gadget's content is also integrated as part of the user's iGoogle™ content.

Suppose victim A may have also subscribed to many other gadgets to customize his iGoogle™ homepage. For example, victim A may have subscribed to an auction site's gadget. In order to subscribe and set up an account to the auction site's gadget, he may have had to input his personal data including, for example, mailing address, phone number, bank account information for purchases, and create a username and password.

Since iGoogle™, like most mashup websites, is implemented using AJAX (Asynchronous JavaScript and XML) technology, the personal data entered by the user is represented in a DOM (Document Object Model). DOM and AJAX technologies are well known in the art and will not be discussed further herein.

Further, the personal data entered by the user is represented in the same DOM tree as xyzwidget gadget. As such, the user's personal data becomes vulnerable to stealing by the malicious codes in xyzwidget gadget, to the detriment of the unwary user.

### SUMMARY OF INVENTION

The invention relates, in an embodiment, to a method for protecting a mashup webpage, the mashup webpages including a plurality of mini-applications. The method includes intercepting a content access event by a first mini-application of the plurality of mini-applications, the content access event requesting access to content of a second mini-application of the plurality of mini-applications. The method also includes ascertaining, using a Document Mini-application Model (DOM) access control policy and a DOM model, whether the content access event is permissible. The DOM access control policy governs access by individual ones of the plurality of mini-applications to content of others of the plurality of mini-applications the DOM access control policy. The DOM model specifies a hierarchical relationship among the plurality of mini-applications. The method additionally includes denying the access by the first mini-application to the content of the second mini-application if the content access event is deemed impermissible or permissible according to the DOM access control policy.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows an example of a mashup webpage as displayed on a user's web browser.

FIG. 2 shows an example DOM tree, representing a hierarchical relationship representation among objects of the mashup webpage of FIG. 1.

FIG. 3 shows, in accordance with an embodiment of the invention, the steps in implementing data security in mashup webpages.

FIG. 4 shows, in accordance with an embodiment of the invention, the steps for implementing data security for mashup webpages.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

Embodiments of the invention relate to techniques, methods, and systems for protecting data in mashup websites. As aforementioned, hackers have traditionally relied on several techniques to steal data from users that utilize a mashup website's service. For example, hackers may employ malicious codes in one gadget to steal data/content associated with other gadgets.

In one aspect of the invention, the inventor herein realized that by providing a cross-object access control policy and employing event detectors to detect event and by ascertaining whether an event initiated by an object comply with the cross-object access control policy before access to content is permitted, content security for all the users that utilize mashup websites would be enhanced.

In one or more embodiments of the invention, after the third-party gadget(s) has/have been integrated as part of a mashup webpage, a hierarchical relationship representation among objects of the mashup webpage is created by performing a scan of the mashup page. As the term is employed herein, a hierarchical relationship representation is a conceptual representation of relationships among objects comprising a mashup webpage. Generally speaking, these relationships include parent, child and/or sibling relationships. In an embodiment, this hierarchical relationship representation is represented by a DOM tree.

In one or more embodiments of the invention, there is provided a cross-object access control policy that is designed to control access by one object of the mashup webpage to content associated with another object of the webpage. For example, a DOM traversal access control policy may be implemented to govern the access (e.g., reading and/or writing) by one gadget of a mashup webpage to content associated with another gadget of that mashup webpage.

Once the hierarchical relationship representation has been generated for the mashup webpage, in an embodiment, event hooks may be implemented at various nodes of the hierarchical relationship representation in order to intercept events. The intercepted events are then analyzed to ascertain whether the intercepted event complies with the cross-object access control policy. For example, a JavaScript DOM event executed by codes of a given gadget may be intercepted (i.e. hooked) in order to ascertain whether the JavaScript DOM event complies with a DOM traversal access control policy.

In one or more embodiments, the cross-object access control policy may include three rules that govern that object's access to 1) its parent objects, 2) its sibling objects, and 3) its child objects. In one or more embodiments, a cross-object access control policy in a mashup webpage may state that an object may not read/write its parent object's content nor can the object read/write its sibling object's content. However, it is possible for the object to read/write its child object's content. In one or more embodiments, these rules have been found to work well in order to provide content security for the mashup webpages. These rules may be codified into the DOM traversal access control policy, in an implementation.

In an embodiment, if the JavaScript DOM event attempts to access either a sibling or parent object, the JavaScript DOM event may be detected and rejected as noncompliance with the DOM traversal access control policy. In this case, a warning may be displayed on the user's web browser to alert the user and to, for example, allow the user to remove the third-party object that is trying to access unauthorized parent or sibling object content. In this manner, the unauthorized access by one object to another object's content is prevented. On the other hand, if the JavaScript DOM event is attempting to access the content of a child object, access to read/write will be granted per the DOM traversal access control policy.

The features and advantages of the invention may be better understood with reference to the figures and discussions that follow.

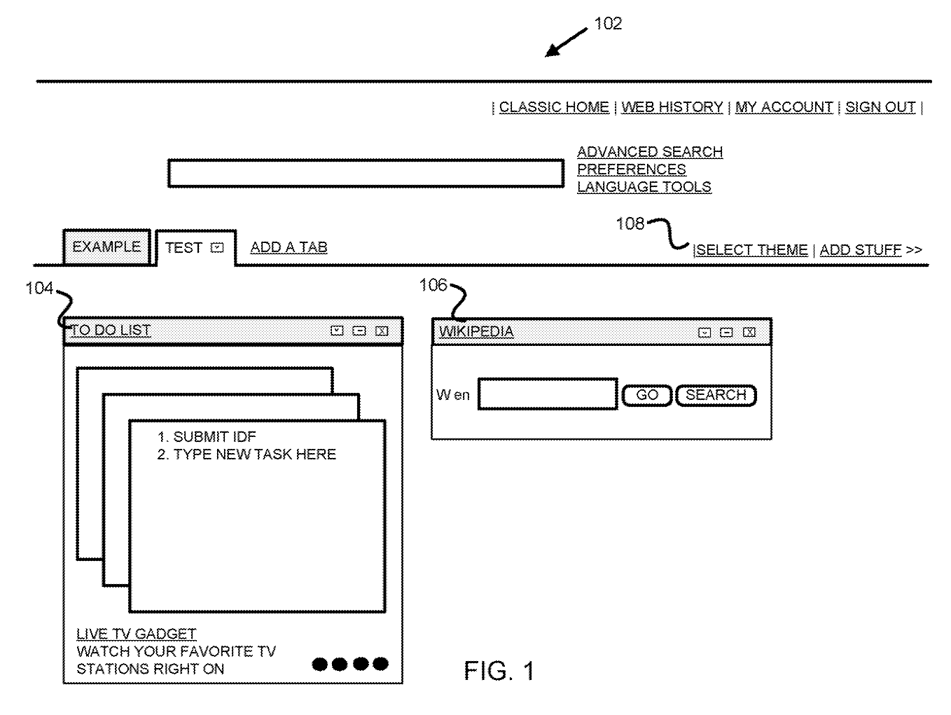

FIG. 1 shows an example of a mashup webpage 102 as displayed on a user's web browser. In FIG. 1, there is shown a gadget 104, representing a “To Do” task list gadget. There is also shown a gadget 106, representing a gadget for searching an online encyclopedia (e.g., wikipedia™ gadget). Each of these gadgets includes codes that implement the functionality as well as data/content (such as the user's personal to-do tasks). A button 108 is shown, representing a button allowing the user to further customize mashup webpage 102 via additional gadgets.

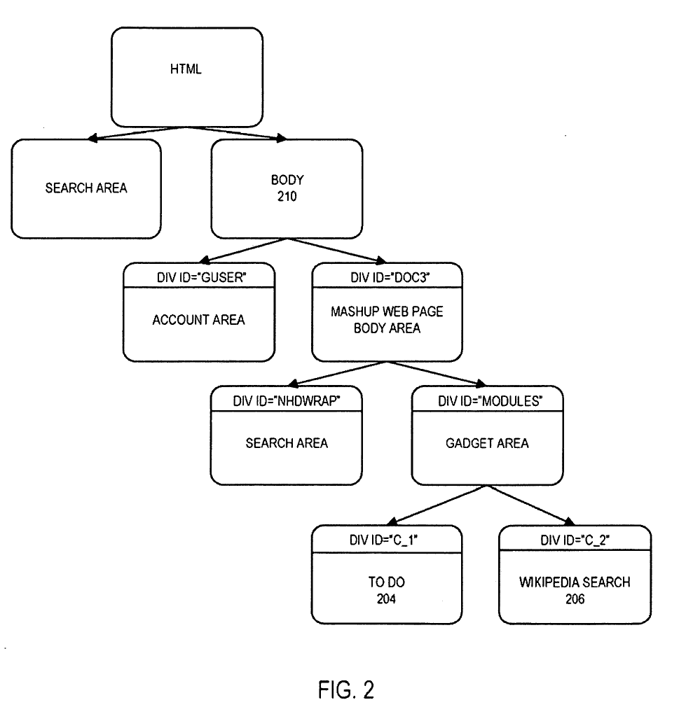

FIG. 2 shows an example DOM tree, representing the hierarchical relationship representation among objects of the mashup webpage of FIG. 1. Such a DOM tree may be generated from the objects programmatically using, for example, a commercially available tool such as by DOM Inspector (DOMi), available from Joe Hewitt and Christopher Aillon (November 11, 2003 revision) and installed as part of the FireFOX™ browser. (http://developer.mozilia.org/en/docs/DOM_Inspector).

“To Do” gadget 104 of FIG. 1 is represented by node 204, while the wikipedia search gadget 106 of FIG. 1 is represented by node 206. In the example of FIG. 2, these two gadgets are sibling objects in the DOM tree. With reference to FIG. 2, iGoogle body area (210) is a parent object of node 204 (“To Do” gadget) and node 206 (“wikipedia”).

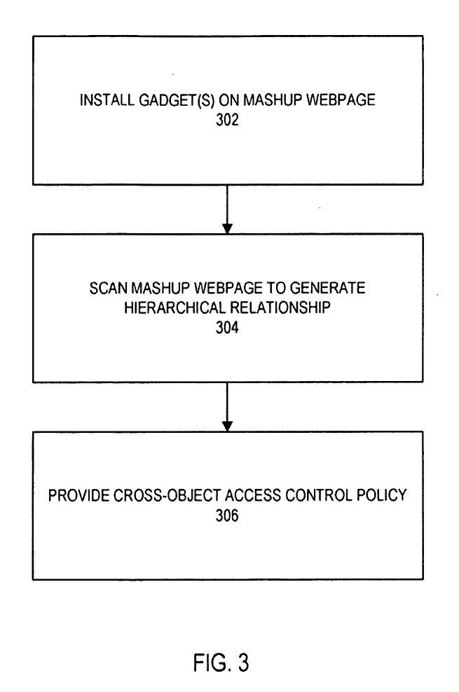

FIG. 3 shows, in accordance with an embodiment of the invention, the steps in implementing data security in mashup webpages. In step 302, the gadget(s) are installed on the mashup webpage. At this point, gadgets may, in an embodiment, be allowed to be installed without regard to whether they contain malicious code. In another embodiment, scanning or detecting malicious codes/data may be attempted prior to permitting the installation to occur.

In step 304, the mashup webpage is then scanned to generate the hierarchical relationship representation. For example, a DOM tree may be generated from the HTML mashup webpage in order to represent the relationships among the objects of the mashup webpage. In step 306, a traversal access control policy, representing the cross-object access control policy, may be provided. This traversal access control policy is configured to govern whether access by one object to the content of another object would be allowable during run-time.

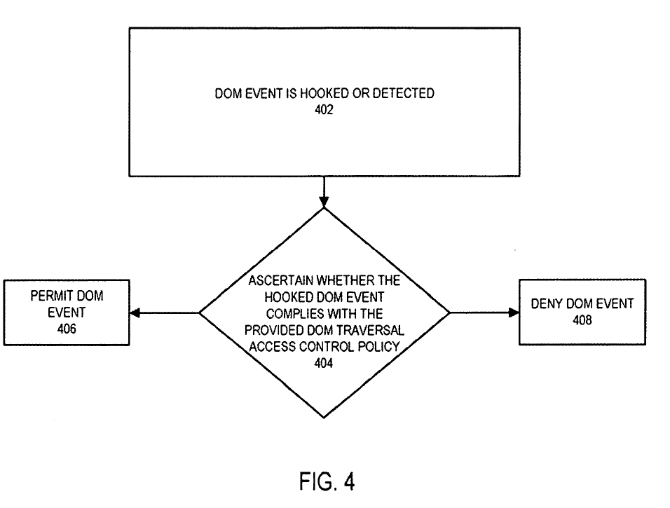

FIG. 4 shows, in accordance with an embodiment of the invention, the steps for implementing data security for mashup webpages. The steps of FIG. 4 are executed during run-time based on the data security framework set up during set-up time (as discussed in connection with FIG. 3). In step 402, a DOM event is hooked or detected. Hooking is a standard technology and is provided by, for example, Microsoft Corporation of Redmond, Wash. In step 404, it is ascertained whether the hooked DOM event complies with the provided DOM traversal access control policy. As discussed, one such policy may state that, for example, an object may not read/write its parent object's content nor can the object read/write its sibling object's content. However, it is permitted for the object to read/write its children object's content.

If the hooked DOM event complies with the DOM traversal access control policy, the event is permitted (406). On the other hand, if the hooked DOM event fails to comply with the DOM traversal access control policy, the event is not permitted (408). In an embodiment, a warning or status message may be sent to the user to inform the user that a particular gadget has codes that violate the DOM traversal access control policy. With the provided warning, the user may elect to uninstall the offending gadget, for example.

As can be appreciated from the foregoing, embodiments of the invention provide security protection for the content for all gadgets in a mashup webpage. Further, the protection can be readily implemented in a mashup webpage even if the individual gadgets themselves are not provided with content security mechanisms. In this manner, the paradigm of mixing or matching of gadgets are still allowed in the creation of a mashup webpage irrespective whether a given gadget is endowed with its own content security protection, and content security is provided for all gadgets without requiring gadget authors to re-program gadget codes.

While this invention has been described in terms of several preferred embodiments, there are alterations, permutations, and equivalents, which fall within the scope of this invention. For example, although AJAX technologies and DOM technologies are discussed as examples of enabling technologies for Rich Internet Applications (RIA) or mashup webpages, other technologies such as Flex (by Adobe Inc. of San Jose, Calif.) or Curl may also be employed. As another example, techniques herein may also be implemented as plug-ins that work with client internet browsers, thereby enabling protection for users when interacting or working with mashup websites.

Also, the title, summary, and abstract are provided herein for convenience and should not be used to construe the scope of the claims herein. It should also be noted that there are many alternative ways of implementing the methods and apparatuses of the present invention. Although various examples are provided herein, it is intended that these examples be illustrative and not limiting with respect to the invention. Further, in this application, a set of “n” items refers zero or more items in the set, as the mathematical definition is intended to be interpreted. It is therefore intended that the following appended claims be interpreted as including all such alterations, permutations, and equivalents as fall within the true spirit and scope of the present invention.

What is claimed is:

1. A method for protecting a mashup webpage, said mashup webpage including a plurality of objects, comprising:
providing a cross-object access control policy, said cross-object access control policy governing access by individual ones of said plurality of objects to content of others of said plurality of objects;
providing a hierarchical relationship representation among objects of said mashup webpage, said hierarchical relationship representation specifying a hierarchical relationship among said plurality of mini-applications;
intercepting a content access event by a first object of said plurality of objects, said content access event requesting access to content of a second object of said plurality of objects;
ascertaining, using said cross-object access control policy and said hierarchical relationship representation, whether said content access event is permissible; and
denying said access by said first object to said content of said second object if said content access event is deemed impermissible or permissible according to said cross-object access control policy.

2. The method of claim 1 further comprising notifying a user of said mashup webpage if said content access event is deemed impermissible according to said cross-object access control policy.

3. The method of claim 1 further comprising permitting said access by said first object to said content of said second object if said content access event is deemed permissible according to said cross-object access control policy.

4. The method of claim 1 wherein said content access event represents a JavaScript DOM event.

5. The method of claim 1 wherein said cross-object control policy permits write access to a child object but inhibits said write access to a parent object.

6. The method of claim 1 wherein said cross-object control policy permits write access to a child object but inhibits said write access to a sibling object.

7. The method of claim 1 wherein said intercepting involves event hooking.

8. The method of claim 1 wherein said plurality of objects represent a plurality of mini applications.

9. The method of claim 1 wherein said mashup webpage is implemented via Rich Internet Application (RIA) technology.

10. The method of claim 1 wherein said mashup webpage is implemented via AJAX (Asynchronous Javascript and XML) technology.

11. A method for protecting a mashup webpage, said mashup webpage including a plurality of mini-applications, comprising:
intercepting a content access event by a first mini-application of said plurality of mini-applications, said content access event requesting access to content of a second mini-application of said plurality of mini-applications;
ascertaining, using a Document Mini-application Model (DOM) access control policy and a DOM model, whether said content access event is permissible, said DOM access control policy governing access by individual ones of said plurality of mini-applications to content of others of said plurality of mini-applications said DOM access control policy, said DOM model specifying a hierarchical relationship among said plurality of mini-applications; and
denying said access by said first mini-application to said content of said second mini-application if said content access event is deemed impermissible or permissible according to said DOM access control policy.

12. The method of claim 11 further comprising notifying a user of said mashup webpage if said content access event is deemed impermissible according to said DOM access control policy.

13. The method of claim 11 further comprising permitting said access by said first mini-application to said content of said second mini-application if said content access event is deemed permissible according to said DOM access control policy.

14. The method of claim 11 wherein said content access event represents a JavaScript DOM event.

15. The method of claim 11 wherein said DOM control policy permits write access to a child mini-application but inhibits said write access to a parent mini-application.

16. The method of claim 11 wherein said DOM control policy permits write access to a child mini-application but inhibits said write access to a sibling mini-application.

17. The method of claim 11 wherein said intercepting involves event hooking.

18. The method of claim 11 wherein said plurality of mini-applications represent a plurality of mini applications.

19. The method of claim 11 wherein said mashup webpage is implemented via Rich Internet Application (RII) technology.

20. The method of claim 11 wherein said mashup webpage is implemented via AJAX (Asynchronous Javascript and XML) technology.
